(19) United States
(12) Patent Application Publication
(10) Pub. No.: US 2005/0132152 A1
(43) Pub. Date: Jun. 16, 2005

(54) Method and apparatus for writing data in a medium, and method and apparatus for reading out data from a medium

(75) Inventor: Kyo-shin Choo, Yongin-shi (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/012,111

(22) Filed: Dec. 16, 2004

(30) Foreign Application Priority Data
Dec. 16, 2003 (KR) 2003-91869

(51) Int. Cl. G06F 12/00

(52) U.S. Cl. 711/154

(57) ABSTRACT

A method and an apparatus for writing data in a recording medium and/or reading out data from the recording medium. In the method and apparatus for reading out and writing data having a second data length unit with respect to a recording medium in which data are processed in a first data length unit, it is judged whether a position at which the data having the second data length unit have been written or will be written in the recording medium is a start portion of data having the first data length unit, and the data having the second data length unit are adaptively written or read out in accordance with the judgment result.

### CROSS-REFERENCE TO RELATED APPLICATION

This application claims the priority of Korean Patent Application No. 2003-91869, filed on Dec. 16, 2003, in the Korean Intellectual Property Office, the disclosure of which is incorporated herein by reference.

### BACKGROUND OF THE INVENTION

1. Field of the Invention

The invention relates to data processing, and more particularly, to a method and an apparatus for reading and/or writing data having a second data length unit with respect to a medium in which data are processed in a first data length unit.

2. Description of the Related Art

Memories store data in a byte unit. However, to improve a memory access speed, data are generally processed in a word unit.

For example, a transmission control protocol (TCP) allows transmission packets to be stored in memory by using a memory buffer (mbuf) scheme. However, when using the mbuf scheme, there exist spaces in which data are not written in the memory, making the memory less efficient.

A lot of time is required for reading and/or writing data because a clock cycle of a byte unit is required to access the memory in a byte unit. In addition, a complex addressing structure is required to access the memory in a byte unit.

Computer hardware uses memory having, a defined size or capacity due to limited resources. The memories are often have a circulation structure for efficient use thereof.

Therefore, it is necessary to develop a method of efficiently reading out and/or writing data having a byte length with respect to memories in which data are processed in a word unit.

### SUMMARY OF THE INVENTION

The invention provides a method and an apparatus for writing data having a second data length unit in a medium in which data are processed in a first data length unit.

The invention also provides a method and an apparatus for reading, or reading out, data having a second data length unit from a medium in which data are processed in a first data length unit.

The invention also provides a computer-readable medium that records a program for enabling a computer to execute the aforementioned methods of reading and/or writing data.

According to an aspect of the invention, there is provided a method of writing data having a second data length unit that is smaller than a first data length unit in a medium in which data are processed in the first data length unit, the method including: judging whether a position at which the data having the second data length unit should be written in the medium is a start portion of data having the first data length unit in the medium; and adaptively writing the data having the second data length unit in the medium in accordance with the judgment result.

According to an aspect of the invention, the adaptive writing of the data having the second data length unit may include reading data having the first data length unit corresponding to the position at which the data having the second data length unit should be written and combining the read data having the first data length unit with the data having the second data length unit to be written; and writing the combined data in the medium in the first data length unit when it is judged that the position at which the data having the second data length unit should be written is not the start portion of the data having the first data length unit.

According to another aspect of the invention, there is provided an apparatus for writing data having a second data length unit that is smaller than a first data length unit in a medium in which data are processed in the first data length unit, the apparatus including: a position judging unit that judges whether a position at which the data having the second data length unit should be written is a start portion of data having the first data length unit in the medium; and an adaptive writing unit that adaptively writes the data having the second data length unit in the medium in accordance with the judgment result.

According to an aspect of the invention, he adaptive writing unit may include a combining unit that reads data having the first data length unit corresponding to the position at which the data having the second data length unit should be written and combines the read data having the first data length unit with the data having the second data length unit to be written; and a writing unit which writes the combined data in the medium in the first data length unit when it is judged that the position at which the data having the second data length unit should be written is not the start portion of the data having the first data length unit.

According to another aspect of the invention, there is provided a method of reading data having a second data length unit that is smaller than a first data length unit from a medium in that data are processed in the first data length unit includes: judging whether a position at that first data having the second data length unit to be read have been written in the medium is a start portion of data having the first data length unit from the medium; and adaptively reading the first data having the second data length unit from the medium in accordance with the judgment result.

According to an aspect of the invention, the adaptive reading of the data having the second data length unit may include reading data having the first data length unit including the first data having the second data length unit from the medium; and removing a portion not corresponding to the first data having the second data length unit from the read data having the first data length unit when it is judged that the first data having the second data length unit does not correspond to a start portion of the data having the first data length unit.

According to another aspect of the invention, there is provided an apparatus for reading data having a second data length unit that is smaller than a first data length unit from a medium in which data are processed in the first data length unit, the apparatus comprising: a position judging unit that judges whether a position at which first data having the second data length unit to be read have been written in the medium is a start portion of data having the first data length unit in the medium; and an adaptive reading unit that adaptively reads the data having the second data length unit from the medium in accordance with the judgment result.

According to an aspect of the invention, the adaptive reading unit may include a data reading unit that reads data having the first data length unit including the first data having the second data length unit from the medium; and a data removing unit that removes a portion not corresponding to the first data having the second data length unit from the read data having the first data length unit when it is judged that the first data having the second data length unit does not correspond to the start portion of the data having the first data length unit.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the invention will become apparent and more readily appreciated from the following description of the embodiments, taken in conjunction with the attached drawings of which:

FIG. 1 is a diagram illustrating a memory 1 in which data are written in a word unit;

FIG. 2 is a diagram illustrating an embodiment of a method of writing data having a byte length in a memory in which data are processed in a word unit;

FIG. 3 is a diagram illustrating an embodiment of a method of writing data when a position at which the data should be written is not a first byte of a word;

FIG. 4 is a flowchart illustrating an embodiment of a method of writing data having a byte length in a memory in which data are processed in a word unit according to the invention;

FIG. 5 is a flowchart illustrating an embodiment of a method of writing data according to the invention when a first byte of the data to be written is not a first byte of a word;

FIG. 6 is a diagram illustrating values of data to be written in the embodiment illustrated in FIG. 2;

FIG. 7 is a diagram illustrating values of data to be written in the embodiment illustrated in FIG. 3;

FIG. 8 is a diagram illustrating reading data having a word length that have been written in a memory in which data are processed in a word unit;

FIG. 9 is a diagram illustrating an embodiment of a method of reading data having a byte length that have been written in a memory in which data are processed in a word unit;

FIG. 10 is a diagram illustrating an embodiment of a method of reading data when a position at which a first byte of data to be read has been stored is not a first byte of a word;

FIG. 11 is a flowchart illustrating an embodiment of a method of reading data having a byte length that have been written in a memory in which data are processed in a word unit according to the invention;

FIG. 12 is a flowchart illustrating an embodiment of a method of reading data having a byte length that have been written in a memory in which data are processed in a word unit according to the invention, wherein a first byte of the data to be read is not a first byte of a word;

FIG. 13 is a diagram illustrating values of data which have been read by applying a method of reading data according to the embodiment illustrated in FIG. 9; and

FIG. 14 is a diagram illustrating values of data that have been read by applying a method of reading data according to the embodiment illustrated in FIG. 10.

FIG. 15 is a diagram illustrating an adaptive writing unit according to an embodiment of the invention.

FIG. 16 is a diagram illustrating an apparatus for reading data according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The invention relates to a method and an apparatus for writing data on a medium, and a method and an apparatus for reading data that is written on the medium.

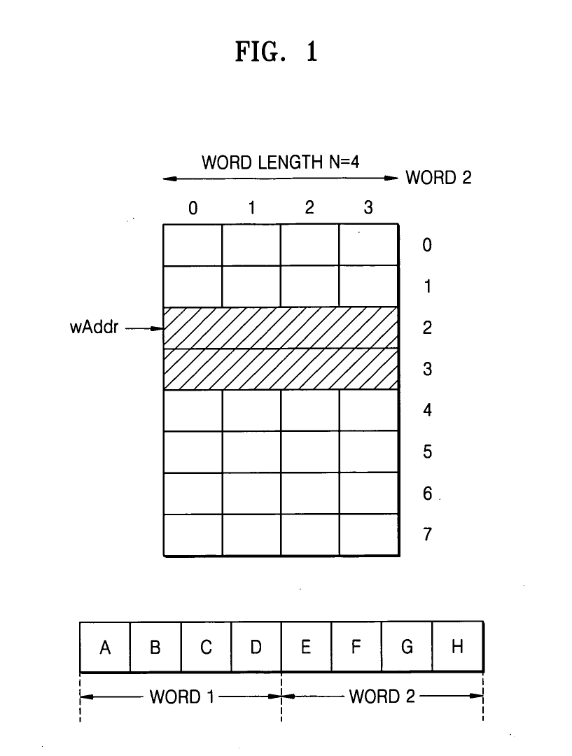

FIG. 1 is a diagram illustrating a memory 1 that stores data in a word unit. A case of writing two-word data in the memory 1 in which a length N of a word is four bytes is shown in FIG. 1. The memory 1 shown to FIG. 1 processes data in a word unit, which indicates that a process of writing and/or reading a word is performed during a clock period or cycle. It is understood that the reading a word comprises reading out a word from a memory.

An address, or data identifier, in the memory 1 should be specified. In FIG. 1, a variable wAddr, which specifies an address at which data are written, indicates an address 2. Therefore, for example, a word ‘ABCD’ is written in the address 2, and each word ‘EFGH’ is written in the address 3. Since a clock period is required for writing a word, two clock periods are required for writing the two words shown in FIG. 1.

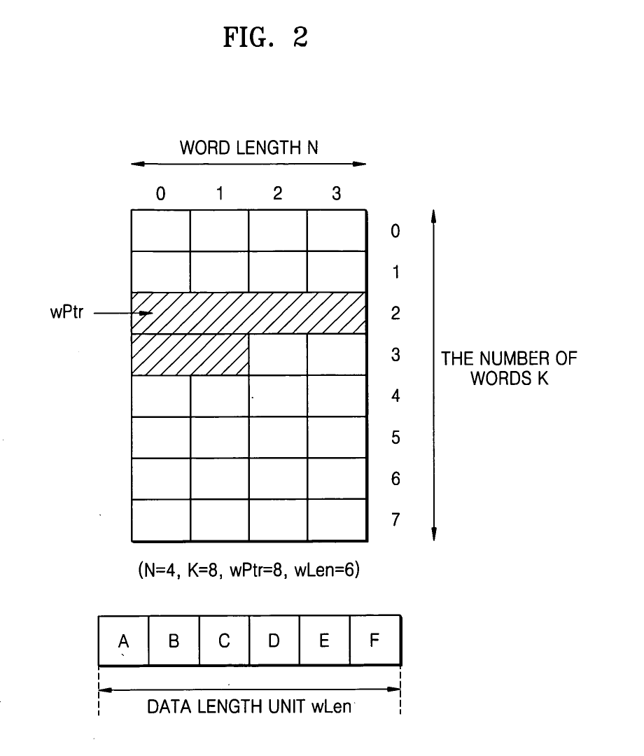

FIG. 2 is a diagram illustrating an embodiment of a method of writing data having a byte length in the memory 1 in which data are processed in a word unit. The memory 1 storing eight words of a 4-byte length is shown in FIG. 2. As shown, data to be written having a six-byte length is written at a position beginning at a first byte of the address 2.

When a length of the data to be written is not divisible by 4 bytes, as shown in FIG. 2, various methods may be used for writing the data. For example, data that is divisible by 4 bytes is data having a 4 byte length, 8 byte length, 12 byte length, etc.

According to an embodiment of the invention, a method of writing the data in a byte unit includes increasing a variable indicating data to be written by one byte. An address in the memory is increased by one byte and the data is stored by one byte, which may be performed at the same time that the variable is increased. Six clock cycles are required in the scenario shown in FIG. 2. Therefore, in this scenario, more time is required than the time required for simply writing data in a word unit. Also, an addressing structure is complicated when the memory 1 has a structure that is capable of being accessed in a byte unit.

The invention relates to a method of writing data having a byte length in a word unit in the memory 1 in which data are processed in a word unit.

According to an embodiment of the invention, the method of writing the data having a byte length in the memory 1 includes at least two general scenarios. One scenario involves a position in which the data having a byte length should be written in the memory 1 starts from a first byte of a word. Another scenario includes a position at which the data having a byte length should be written in the memory 1 does not start from a first byte of a word.

FIG. 2 illustrates the scenario where a position at which the data having a byte length is written in the memory 1 starting from a first byte of a word. A variable wPtr indicating a position at which the data having a byte length should be written specifies an address of a byte unit. In FIG. 2, a value of WPtr is 8.

In order to write data having a length of six bytes from the byte address 8 to the byte address 13 in a word unit, two bytes are added to a rear end of the data to form eight bytes, that is, two words. Data of the two words are written in word addresses 2 and 3, respectively. Therefore, data of six bytes can be written during two clock cycles. At that time, since values of the two-byte data added to the rear end of the data do not have meaning, values at original positions may be used without any separate addition. It is understood that all addresses starts from an address 0 in this specification.

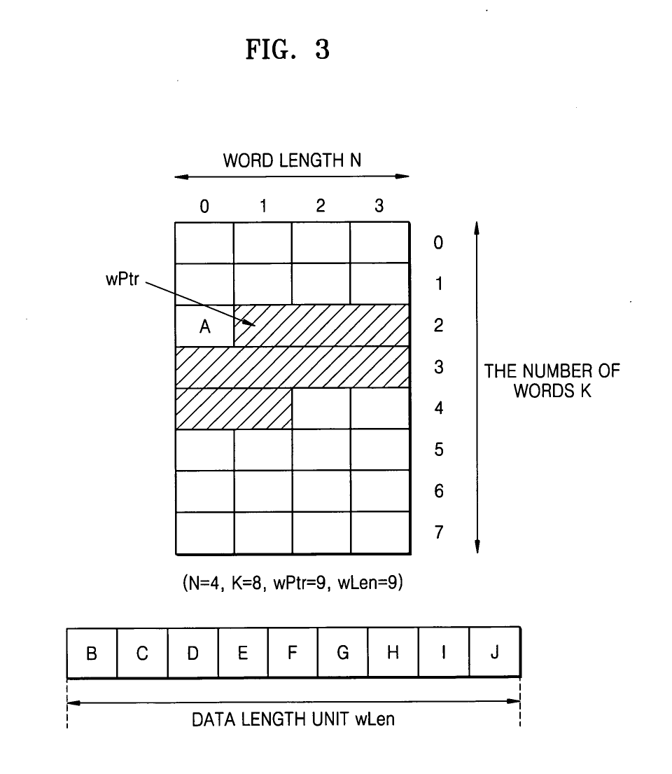

FIG. 3 is a diagram illustrating an embodiment of a method of writing data when a position at which the data should be written is not a first byte of a word.

A memory having eight words of a four-byte length is shown in FIG. 3. A variable wPtr indicating a position at which data should be written has a value of 9. In FIG. 3, in order to write data in a word unit, one byte is added to a front end of the data and two bytes are added to a read end of the data to form three words, and then the three words are written at addresses 2 to 4, respectively. Since “A” is already written at a first byte of a word in the address 2 of the memory 1, data “A” is lost if the data is written without a pre-processing operation. Therefore, a pre-processing operation of reading a value of “A” already written in the memory 1 and adding the value to a front end of the data is required.

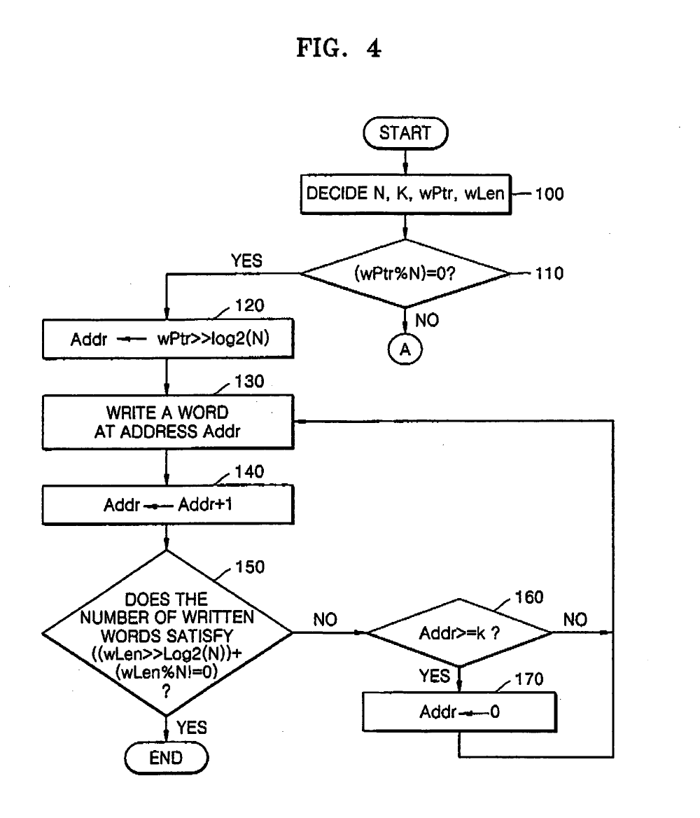

FIG. 4 is a flowchart illustrating an embodiment of a method of writing data having a byte data length unit in the memory 1 in which data are processed in a word unit according to an embodiment of the invention.

A scenario where a position at which data should be written is a first byte of a word is shown in FIG. 4. Referring to FIG. 4, a length N of bytes included in a word, the number K of words included in a memory, a byte address wPtr of a position at which data should be written, and a byte length wLen in data to be written are decided in operation (100).

A position at which a first byte of data should be written is a first byte of a word is determined in operation 110 (110). The embodiment of FIG. 4 illustrates a scenario of executing operation 110 using a value of wPtr % N, which is a remainder obtained by dividing wPtr by N. Since the embodiments of the invention presume that addresses of the memory start from address 0, an address of the byte unit for the first byte of each word is a multiple of N. Therefore, when an address of a byte unit is divided by N, a first byte of a word has a remainder of 0 and the other bytes of the word have remainder values other than zero.

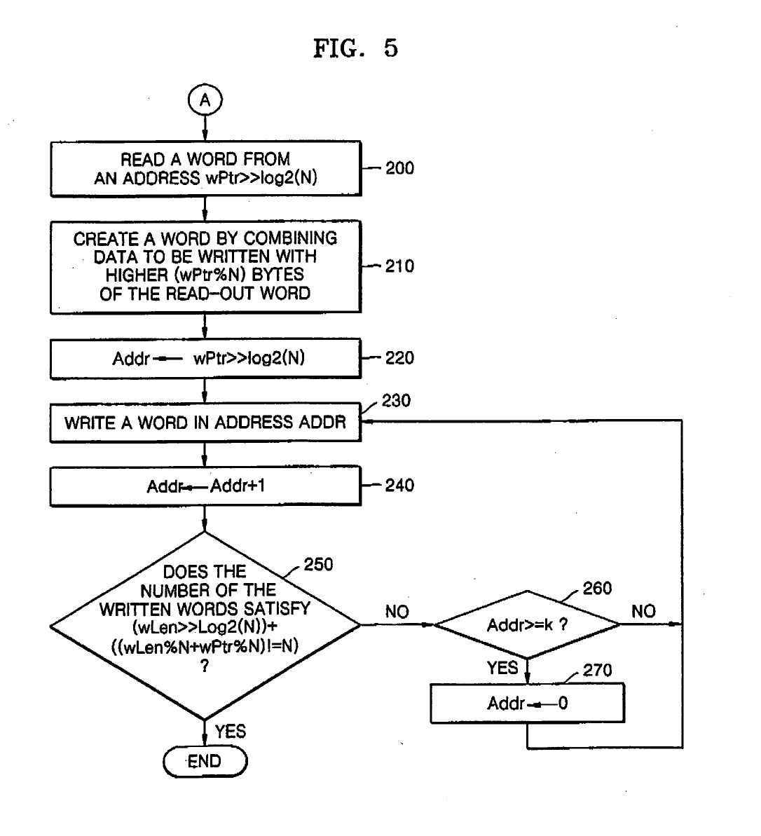

A remainder of 0, indicates that data are written from a first byte of a word. When the remainder is not 0, this indicates that data are not written from the first byte of a word; therefore, the aforementioned pre-processing operation should be performed, as shown in FIG. 5.

When the remainder value is 0, a particular pre-processing operation is not required. A value obtained by dividing the address wPtr of a byte unit at which data should be written by N is provided to a variable Addr specifying a memory address of a word unit. At that time, the division is an integer operation, that is, an operation causing a share and a remainder. For example, 9 divided by 4 does not make 2.25, but makes a share of 2 and a remainder of 1. Operation 120 of FIG. 4 represents a scenario of performing such an operation by using wPtr>>log2 (N), which is a bit unit operation. In this expression, the symbol “>>” indicates a shift operation of a bit unit, and log2 (N) indicates a logarithm operation in which a base is 2. Therefore, wPtr is shifted to the right by log2 (N) in a bit unit. For example, when N=4 and wPtr=9, a bit expression of wPtr is 1001 and log2 (N) is 2, whereby the operation wPtr>>log2 (N) gives 0010, that is, 2. Therefore, a share of division of wPtr=9 by 2 can be obtained as 2. In addition, the variable Addr indicates address 2 at which the first word of data should be written.

Data are written in a word unit at a position indicated by Addr, and the words of the data are written in the memory through a process of increasing Addr by one. First, the first word is written at address Addr. A value of Addr is then increased by one in operation 140. This process is repeated until all the words of the data to be written are stored in the memory. In operation 150, it is determined whether the number of words stored is equal to the number of words of the data to be written. When it is determined that the number of stored words is equal to the number of words of the data to be written, the process is completed. However, when it is determined that they are not equal, the procedure returns to operation 130 and is repeated until the remaining words are written.

According to another embodiment of the invention described above, since the memory capacity is limited, a memory having a circulation structure is used. Therefore, when a value of Addr is larger than K−1, which indicates the last word of the memory, the address extends beyond an area of the memory. Therefore, it is determined whether Addr is larger than or equal to Kin operation 160. When it is determined that the Addr is larger than or equal to K, the value of Addr is changed into address in operation 170, 0, which indicates a start end of the memory (170).

FIG. 5 is a flowchart illustrating the method of writing data according to an embodiment of the invention when the remainder value is not 0 in operation 110, i.e., when the first byte of the data to be written is not the first byte of a word. In operation 200, a word corresponding to the first byte of the data to be written is read. An example where the address of the word corresponding to the first byte is obtained by using a method in which a share of the address is calculated by using the bit operation wPtr>>log2 (N) is shown in FIG. 5. This operation is the same as the operation used in operation 120 of FIG. 4.

A new word is created by adding bytes other than the first byte of the read word indicated by wPtr to a front portion of the data to be written (210). For this purpose, as many of the higher bytes are removed from the read data as the remainder count obtained by dividing wPtr by N, as shown in FIG. 5. For example, when wPtr=9 and N=4, wPtr % N=1, so that the highest byte to be added is added to the front portion of the data to be written. Therefore, the data to be written becomes new data including the added byte.

Combined data are written in the same manner as described in the embodiment shown in FIG. 4. For example, in operation 220, first, a value obtained by dividing the address wPtr of a byte unit, which data should be written at, by N is provided to a variable of Addr indicating a memory address of a word unit. The remainder operation is then performed by using the bit unit operation of wPtr>>log2 (N), as described in the embodiment shown in FIG. 4. Data are then written at the position indicated by Addr in a word unit, and the words of the data are written in the memory via a process of increasing Addr by one. For example, in operation 230, the first word is written at address Addr. Subsequently, in operation 240, the Addr is increased by one. The above-described process is repeated until all the words of the data to be written are stored. For this purpose, in operation 250, it is judged whether the number of written words is equal to the number of words of the data to be written. When the number of written words is equal to the number of words to be written, the process is completed. When it is judged that the number of written words is not equal to the number of words to be written, the procedure returns to operation 230 and the remaining words are written.

As described above with respect to the operation shown in FIG. 4, in operation 260, it is judged whether Addr is larger than or equal to K. When it is judged that Addr is larger than or equal to K, the value of Addr is changed to 0 in operation 270, which indicates the start portion of the memory. The above described process is repeated until all the words of the data to be written are stored.

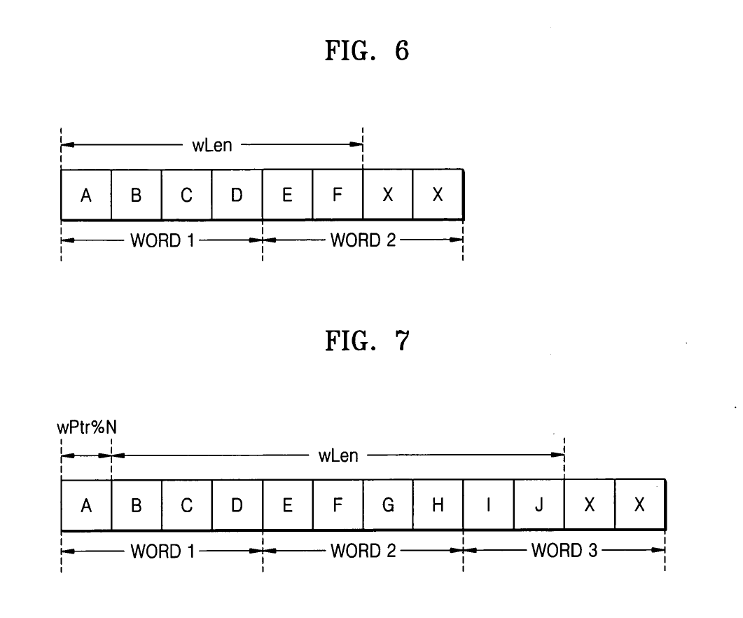

FIG. 6 is a diagram illustrating values of data to be written in the embodiment shown in FIG. 2. In the embodiment shown in FIG. 2, the first byte of the data to be written is the first byte of a word, so that the data are written by using a same or similar method shown in FIG. 4.

As described above, two bytes are added to a rear portion of data having six bytes words and thus the data of two words are written in the memory. When the data is written into the memory, the last 2 bytes of the second word can be neglected. This is generally referred to as a “don't care” value or dummy variable, and is indicated by ‘X’ in FIG. 6.

FIG. 7 is a diagram illustrating values of data to be written in the embodiment shown in FIG. 3. In the embodiment shown in FIG. 3, the first byte of the data to be written is not the first byte of a word, so that the data are written by using a same or similar method shown in FIG. 5. For example, a word at address 2 corresponding to the first byte of the data to be written is read at operation 200. A higher (wPtr % N) byte, that is, one byte of the word read at operation 210 is added to a front portion of the data to be written. Referring to FIG. 7, the data have a length of three words through such a pre-processing step. The last two bytes of word 3 have the “don't care” value as in the scenario described above in FIG. 6. Thus, by writing three words, data having 9 bytes can be written for three clock cycles.

In this way, by using the above described method of writing data in the memory, the memory spaces which have not been used in the method of writing data only in a word unit can be used, thereby improving the efficiency of the memory. In addition, because the access time to the memory can be reduced as compared with the method of writing data only in a byte unit, the storing time is reduced. Further, the complex addressing structure of the memory required in the method of writing data only in a byte unit is not necessary.

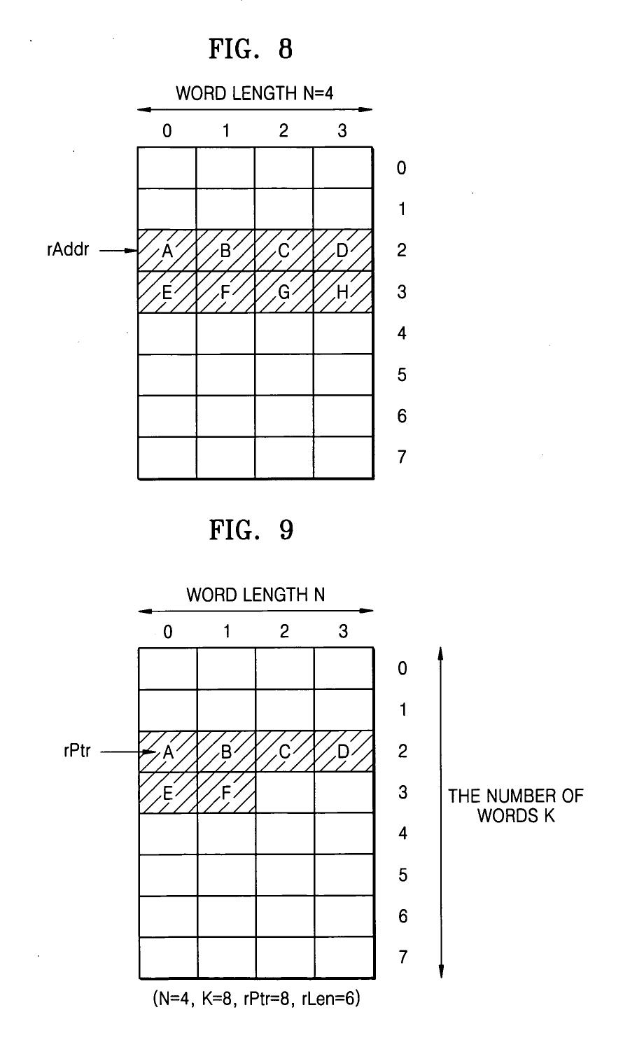

FIG. 8 is a diagram illustrating a scenario where data having a word unit length from the memory in which data are processed in a word unit. In FIG. 8, the data having a length of two words are read when the length N of a word is 4 bytes. A variable “rAddr” specifying an address from which data should be read indicates address 2. Therefore, the words stored at address 2 are read for a clock cycle, and the words stored at address 3 are read for a next clock cycle. In this way, data ‘ABCDEFGH’ having a two-word length can be read.

FIG. 9 is a diagram illustrating an embodiment of the method of reading data having a byte unit length stored in a memory in which data are processed in a word unit. In FIG. 9, a length N of a word is 4 bytes, and the number K of words included in the memory is 8. Address rPtr of a byte unit indicating the first byte of data indicates address 8, and a data length rLen of a byte unit is 6 bytes. That is, FIG. 9 illustrates a scenario where data ‘ABCDEF’ of 6 bytes are read from address 8 of a byte unit.

Similar to the scenario described with respect to FIG. 2, more time are required for reading data having a byte unit length in a byte unit, compared with when data are read in a word unit as compared with when data are read in a word unit. Further, a complex addressing structure is required for accessing data in a byte unit. FIG. 9 shows a scenario where the position at which the first byte of data to be read is stored is the first byte of a word.

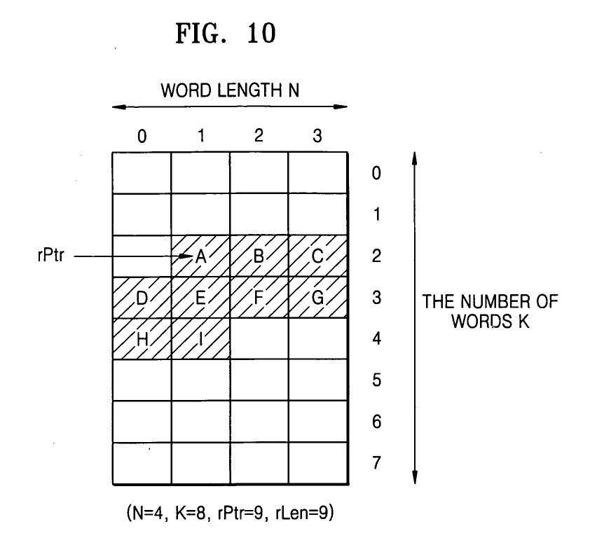

FIG. 10 is a diagram illustrating an embodiment of the method of reading data, when the position at which the first byte of data to be read is stored is not the first byte of a word. In FIG. 10, a memory including eight words having a four-byte length is shown. The variable rPtr indicating a position from which data should be read by using an address of a byte unit is address 9.

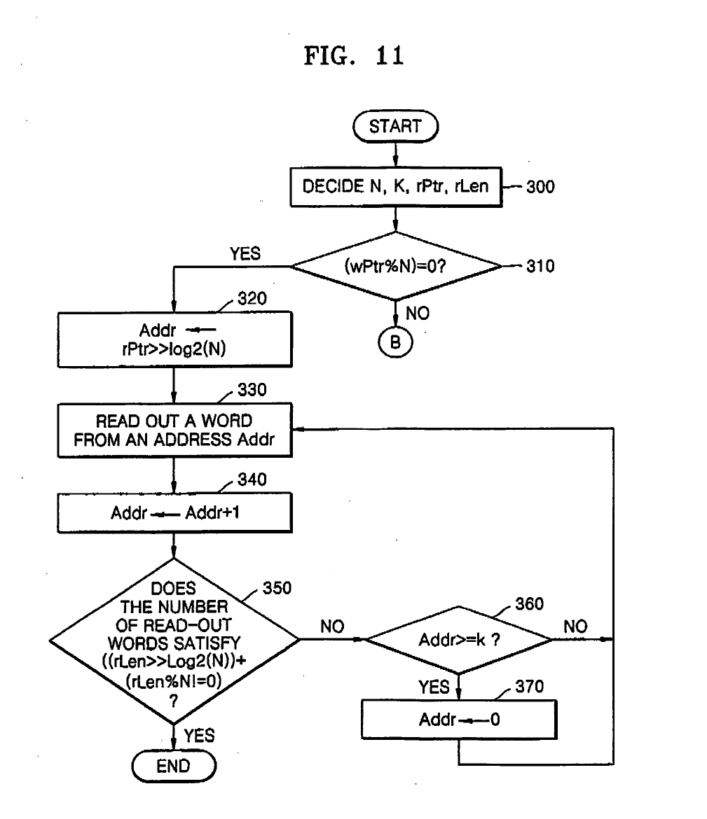

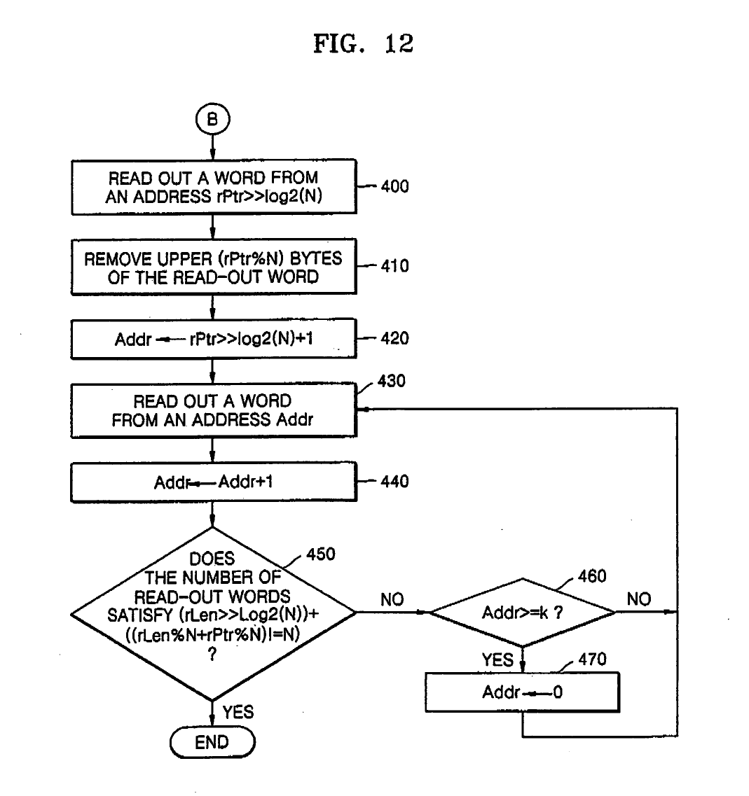

FIG. 11 is a flowchart illustrating a method of reading data having a byte-unit length that is stored in a memory of a word unit according to an embodiment of the invention. In FIG. 11, a scenario where the first byte of data to be read is the first byte of a word is shown. A case where the first byte of data to be read is not the first byte of a word is shown in FIG. 12.

In FIG. 11, a length N of bytes included in a word, the number of words K included in the memory, a byte address rPtr of a position where the data to be read are stored, and a byte length rLen of the data to be read are determined in operation 300. In operation 310, it is judged whether a position where the first byte of the data to be read is stored is the first byte of a word. The foregoing operation may be performed by using a remainder obtained by dividing rPtr by N, that is, a value of rPtr % N. The operation used in this embodiment is similar to the operation used at operation 110 of the embodiment shown in FIG. 4.

When the remainder is 0, operation 320 is performed, because the first byte of the data to be read is the first byte of a word. When the remainder is not 0, the operations shown in FIG. 12 should be performed. Thus, when the remainder is 0, a share obtained by dividing the byte address rPtr, by N is provided to the variable Addr that specifies a word address in the memory in operation 320. For example, operation 320 may be performed by using an operation of rPtr>>log2 (N). This operation is similar to the operation performed in operation 120 of FIG. 4.

In operation 330, a word is read from the address Addr. In operation 340, the value of Addr is increased by one. When the number of read words is equal to the number of words in the data, the process is completed. However, when the number of read word is not equal to the number of words in the data, the procedure returns to operation 330 and the remaining words are read.

In a scenario of using a memory having a circulation structure in operation 360, it is judged whether the value of Addr is larger than or equal to K. When it is judged that the value of Addr is larger than or equal to K, the value of Addr is changed to 0 in operation 370.

FIG. 12 is a flowchart illustrating an embodiment of the method of reading data having a byte-unit length stored in a memory of a word unit when the remainder is not 0 at operation 310, that is, when the first byte of data to be read is not the first byte of a word.

In operation 400, a word corresponding to the first byte of the data to be read is read. Bytes other than the first byte of the data to be read are removed from the read word in operation 410. Next, an address of a word next to the read word is assigned to the value of Addrin operation 420. According to an aspect of the invention, when writing data, data should be written in the memory after performing the pre-processing operation of reading the first word stored in the memory and combining the read first word with data to be written. However, in the method of reading data, it is not necessary to repeatedly read the first data because the first data has already been read.

All the words of the data are read by repeating processes of reading the words from the address of Addr in operation 430, and increasing the value of Addr by one in operation 440.

Further, in the memory having a circulation structure in operation 460, it is judged whether the value of Addr is larger than or equal to K. When it is judged that the value of Addr is larger than or equal to K, the value of K is changed to 0 in operation 470.

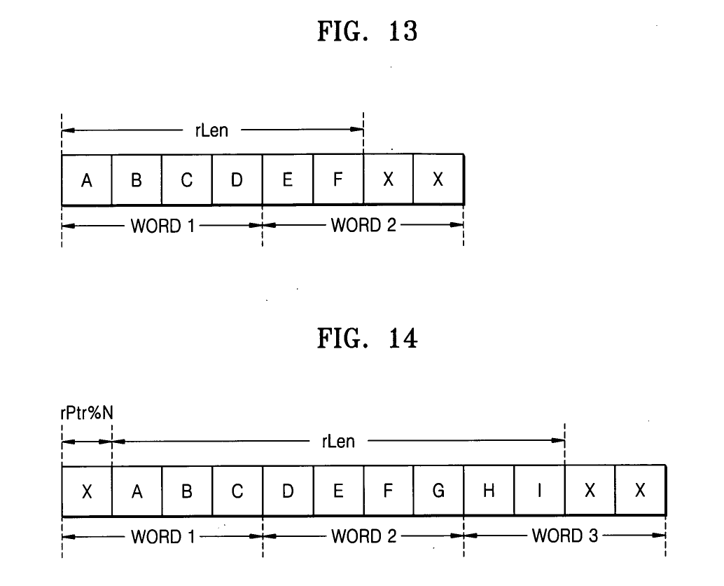

FIG. 13 is a diagram illustrating values of data read by applying the method of reading data according to an embodiment of the invention shown in FIG. 9. In the scenario shown in FIG. 9, the first byte of the data to be read is the first byte of a word, so that the data are read using the method shown in FIG. 11. Since the last two bytes of the second word have “don't care” value, the bytes are indicated by ‘X’ in FIG. 13.

FIG. 14 is a diagram illustrating values of data read by applying the method of reading data according to an embodiment of the invention shown in FIG. 10. In the scenario shown in FIG. 10, the first byte of the data to be read is not the first byte of a word, so that the data are read using the method shown in FIG. 12. Referring to FIG. 14, a higher one byte of word 1 and lower two bytes of word 3 have “don't care” value. As described above, the bytes having the “don't care” value is removed. The higher byte refers to a byte in a beginning space of a word and a lower byte refers to a byte located after a position of a word having a value.

According to the method of reading data from the memory according to an embodiment of the invention, the data stored in a byte unit in the memory in which data are processed in a word unit can be read in a word unit. As a result, it is possible to maintain the efficiency of the memory, which stores data in a byte unit, and to reduce the processing time by using the memory access of a word unit. In addition, a complex addressing structure required in the memory in which data are processed only in a byte unit is not necessary.

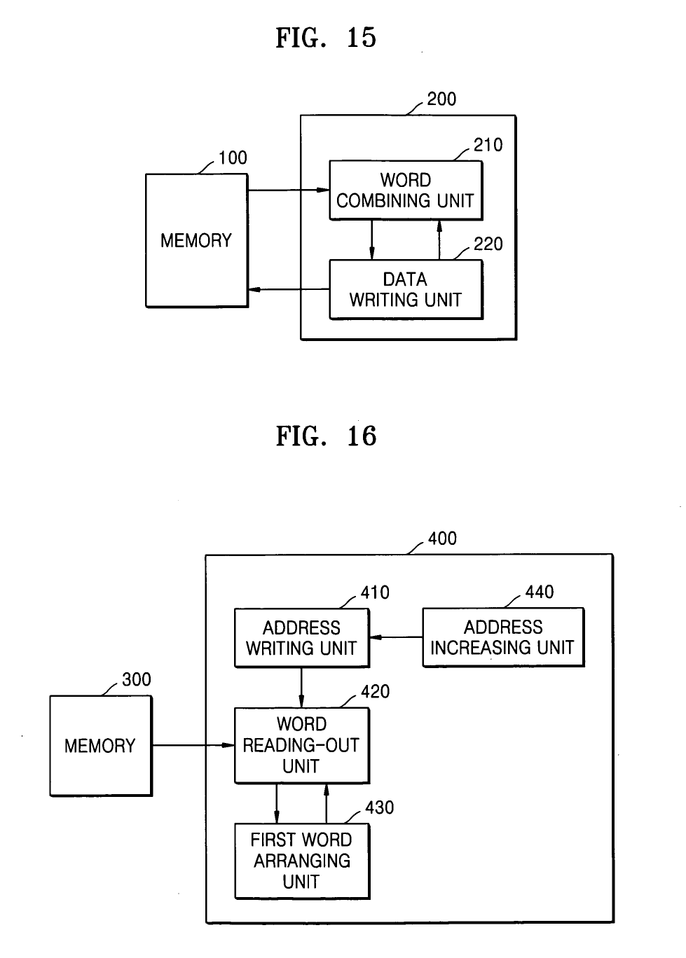

According to an embodiment of the invention as shown in FIG. 15, the adaptive writing unit 200 may include a combining unit 210 that reads data having the first data length unit corresponding to the position at which the data having the second data length unit should be written and combines the read data having the first data length unit with the data having the second data length unit to be written; and a data writing unit 220 that writes the combined data in the medium in the first data length unit when it is judged that the position at which the data having the second data length unit should be written is not the start portion of the data having the first data length unit. A memory unit 100 may be connected with adaptive writing unit 200 such that data is transmitted from the memory unit 100 to the combining unit 210 and from the data writing unit 220 to the memory unit 100.

According to an embodiment of the invention as shown in FIG. 16, an apparatus 400 for reading data having a second data length unit smaller than a first data length unit from a medium in which data are processed in the first data length unit, the apparatus includes an address writing unit 410 to write an address value for each of the first data length units to be stored in the memory, a word reading-out unit 420 that reads data having the second data length unit from the medium and is connected with the memory, and a first word arranging unit 430 that positions and/or arranges the first word of the read data and is connected with the word reading-out unit 420. The apparatus 400 may further include an address increasing unit 440 to count the number of assigned address values.

According to another embodiment of the invention, the above described embodiments can be embodied as computer readable codes on a computer (including all apparatuses having a data processing function, specifically, a user terminal) readable medium to be read by at least one computer. The computer readable medium is any data storage device that can store data that can be thereafter read by a computer system. Examples of the computer readable medium include read-only memory (ROM), random-access memory (RAM), CD-ROMs, magnetic tapes, floppy disks, optical data storage devices, and carrier waves (such as data transmission through the Internet).

According to the method and the apparatus for reading and/or writing data having a second data length unit with respect to the medium in which data are processed in the first data length unit, by judging whether the position at which the data having the second data length unit should be read or written is the start portion of the data having the first data length unit and adaptively writing and/or reading the data having the second data length unit in accordance with the judgment result, spaces in the medium which are not used when data are written and/or read only in the first data length unit can be utilized, to increase the efficiency of the medium, and to reduce the access time to the medium as compared with a case where data are written and/or read only in the second data length unit. In addition, there is an advantage that a complex addressing structure is not required.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of writing data having a second data length unit that is smaller than a first data length unit in a medium in which data are processed in the first data length unit, the method comprising:
judging whether a position at which the data having the second data length unit should be written is a start portion for data having the first data length unit in the medium; and
adaptively writing the data having the second data length unit in the medium in accordance with the judging result.

2. The method of writing data according to claim 1, wherein the adaptive writing of the data having the second data length unit comprises:
reading the data having the first data length unit corresponding to the position at which the data having the second data length unit should be written when it is judged that the position at which a first byte of the data having the second data length unit should be written is not the start portion of the data having the first data length unit;
combining the read data unit with the data having the second data length unit; and
writing the combined data in the medium in the first data length unit.

3. The method of writing data according to claim 1, wherein the first data length unit is a word, and the second data length unit is a byte; and
wherein the judging comprises determining whether a writing address indicating a position at which a first byte of the data having the second data length unit corresponds with a first byte of a word having a plurality of bytes in the medium.

4. The method of writing data according to claim 3, wherein the judging further comprises:
determining whether a remainder value that is obtained by dividing the writing address by a word length corresponds with the first byte of the word.

5. The method of writing data according to claim 3, wherein the adaptive writing of the data having the second data length unit comprises:
reading a word corresponding to the writing address when it is judged that the writing address does not correspond to a first byte of the word;
combining the read word with the data having the second data length unit; and
writing the combined data in the medium in a word unit.

6. The method of writing data according to claim 5, wherein the reading the word corresponding to the writing address and combining the read word with the data having the second data length unit comprises:
removing a byte from the read word; and
adding the removed byte to a portion of the data having the second data length unit.

7. The method of writing data according to claim 6, wherein the removed byte corresponds with a remainder value that is obtained by dividing the writing address in the medium by a word length, and wherein the removed byte is added to a front portion of the data having the second data length unit.

8. The method of writing data according to claim 5, wherein the writing of the combined data comprises:
writing a word of the combined data in a position corresponding to the writing address in the medium; and
increasing the writing address by an amount corresponding to the word length.

9. The method of writing data according to claim 7, wherein when the writing address extends beyond a predetermined area of the medium, the increasing of the writing address by the word length comprises:
changing the writing address to an address indicating a start portion of the medium.

10. The method of writing data according to claim 3, wherein when it is judged that the writing address corresponds with the first byte of a word, the adaptive writing of the data having the second data length unit comprises:
writing the data in the medium in a word unit.

11. The method of writing data according to claim 10, wherein the writing of the data in the word unit comprises:
writing a word of the data having the second data length unit in a position indicated by a writing address in the medium; and
increasing the writing address by an amount corresponding to a word length.

12. The method of writing data according to claim 11, wherein when the writing address extends beyond a predetermined area of the medium, the increasing of the writing address by the word length comprises:
changing the writing address to an address indicating a start portion of the medium.

13. A method of reading data having a second data length unit that is smaller than a first data length unit from a medium in which data are processed in the first data length unit, the method comprising:
judging whether a position at which data having the second data length unit to be read have been written in the medium is a start portion of data having the first data length unit in the medium; and
adaptively reading the first data from the medium in accordance with the judging result.

14. The method of reading data according to claim 13, wherein the adaptively reading of the data having the second data length unit comprises: when it is judged that the first data having the second data length unit does not correspond to the start portion of the data having the first data length unit,
reading the data having the first data length unit and the data having the second data length unit from the medium; and
removing a portion of the read data having the first data length unit that does not correspond with the read data having the second data length unit.

15. The method of reading data according to claim 13, wherein the first data length unit is a word and the second data length unit is a byte; and
wherein in the judging, it is judged whether a first byte of the data to be read corresponds with a first byte of a word having a plurality of bytes in the medium.

16. The method of reading data according to claim 15, wherein the judging further comprises:
determining whether a remainder value corresponds with the first bye of the word,
wherein the remainder value is obtained by dividing a writing address of a position where the first byte of the data to be read has been written in the medium by a word length.

17. The method of reading data according to claim 16, wherein the adaptive reading of the data having the second data length unit comprises:
reading a word corresponding to the writing address from the medium when it is judged that the writing address does not correspond to the first byte of the word; and
removing at least one byte other than the first byte of the data having the second data length unit from the read word.

18. The method of reading data according to claim 17, wherein the removed at least one byte is an upper byte of the read data having the second data length unit.

19. The method of reading data according to claim 18, the removing of at least one upper byte other than the first byte of the data having the second data length unit from the read word comprises:
removing a number of the at least one upper byte of the read word that corresponds with the remainder value.

20. The method of reading data according to claim 19, wherein the number of removed at least one upper byte of the read word is equivalent to the remainder value.

21. The method of reading data according to claim 17, the adaptive reading of the data having the second data length unit comprises:
increasing the writing address by the word length.

22. The method of reading data according to claim 21, the increasing of the writing address by the word length comprises:
changing the writing address to an address indicating a start portion of the medium when the writing address extends beyond a predetermined area of the medium.

23. The method of reading data according to claim 15, wherein the adaptive reading of the data having the second data length unit comprises:
reading a word corresponding to the writing address from the medium when the writing address corresponds with the first byte of the word; and
increasing the writing address by the word length.

24. The method of reading data according to claim 23, the increasing of the writing address by the word length comprises:
changing the writing address to an address indicating a start portion of the medium, when the writing address extends beyond a predetermined area of the medium.

25. An apparatus for writing data having a second data length unit smaller than a first data length unit in a medium in which data are processed in the first data length unit, the apparatus comprising:
a position judging unit that determines whether a position at which the data having the second data length unit should be written is a start portion of data having the first data length unit in the medium; and
an adaptive writing unit that adaptively writes the data having the second data length unit in the medium in accordance with the judgment result.

26. An apparatus for reading data having a second data length unit smaller than a first data length unit from a medium in which data are processed in the first data length unit, the apparatus comprising:
a position judging unit which judges whether a position at which first data having the second data length unit to be read have been written in the medium is a start portion of data having the first data length unit in the medium; and
an adaptive reading-out unit that adaptively reads out the first data having the second data length unit from the medium in accordance with the judgment result of the position judging unit.

27. A computer-readable medium that records a program for enabling a computer to execute a method of writing data having a second data length unit that is smaller than a first data length unit in another medium in which data are processed in the first data length unit, the method comprising:
judging whether a position at which the data having the second data length unit is a start portion for data having the first data length unit in the another medium; and
adaptively writing the data having the second data length unit in the medium in accordance with the judging result.

28. A computer-readable medium which records a program for enabling a computer to execute a method of reading data having a second data length unit smaller than a first data length unit from another medium in which data are processed in the first data length unit, the method comprising:
judging whether a position at which first data having the second data length unit to be read have been written in the medium is a start portion of data having the first data length unit in the another medium; and
adaptively reading the first data having the second data length unit from the another medium in accordance with the judging result.

29. A method of storing a byte date length unit of data in a memory of a computer-device to be processed in a data length unit that is greater than the byte data length unit, the method comprising:
setting the data length unit according to a desired number of byte data lengths; and
dividing the memory area into a predetermined number of the set data length units so that data having the byte data length is stored in the greater data length unit to be processed,
wherein when a byte address of a first byte of data to be stored in the memory is divided by a value of the set data length unit that is equivalent to the desired number of byte data lengths and there is a remainder, the first byte of data to be stored in the memory is shifted by an amount corresponding with the remainder.

30. The method of storing data of the byte data length in the memory according to claim 29, further comprising:
assigning an address value to each of the set data length units of data to be stored in the memory; and
determining whether the data exceeds a data storage capacity of the memory according to the assigned address values.

31. The method of storing data of the byte data length in the memory according to claim 30, wherein when one of the assigned address values indicates that the data storage capacity of the memory is exceeded, the assigned address value is re-assigned to indicate a starting portion of the memory.

32. The method of storing data of the byte data length in the memory according to claim 29, wherein the desired number of byte data lengths for setting the data length unit is a multiple of four, and wherein the set length unit is a word unit.

33. The method of storing data of the byte data length in the memory according to claim 29, further comprising:
writing data from the memory to a medium according to one clock cycle for each of the set length units of data to be written in the medium.

34. The method of storing data of the byte data length in the memory according to claim 29, further comprising:
storing dummy values in a set data length unit when the data stored in the set data length unit is an amount less than the desired number of byte data lengths; and removing the dummy variables when writing the data in a medium.

35. The method of storing data of the byte data length in the memory according to claim 29, further comprising:
storing the data in the memory in a circular manner to more efficiently utilize memory space.
